(19) United States
(12) Patent Application Publication
(10) Pub. No.: US 2018/0164726 A1
(43) Pub. Date: Jun. 14, 2018

(54) IMAGE FORMING APPARATUS

(71) Applicant: Konica Minolta, Inc., Tokyo (JP)

(72) Inventors: Takanobu SHIKI, Sagamihara-shi (JP); Tadayuki UEDA, Tokyo (JP); Hiroshi OYAMA, Tokyo (JP); Satoshi MIYAJIMA, Tokyo (JP); Remi ISHIKAWA, Tokyo (JP)

(73) Assignee: Konica Minolta, Inc., Tokyo (JP)

(21) Appl. No.: 15/815,888

(22) Filed: Nov. 17, 2017

(30) Foreign Application Priority Data
Dec. 12, 2016 (JP) 2016-240681

(51) Int. Cl. G03G 15/00

(52) U.S. Cl. CPC G03G 15/50; G03G 15/6529

(57) ABSTRACT

An image forming apparatus includes: a conveyor that conveys a sheet; a detector that detects an end position of the sheet conveyed by the conveyor in a second direction orthogonal to a first direction being a conveyance direction; a corrector that corrects deviation of the sheet by moving the sheet in the second direction on the basis of a detection result of the end position of the sheet in the second direction detected by the detector, and a hardware processor that obtains variation information based on the end position of the sheet detected by the detector, and adjusts an interval of the conveyed sheet while controlling operation of the corrector on the basis of the obtained variation information.

Japanese Patent Application No. 2016-240681 filed on Dec. 12, 2016, including description claims, drawings, and abstract the entire disclosure is incorporated herein by reference in its entirety.

### BACKGROUND

### Technological Field

The present invention relates to an image forming apparatus.

### Description of the Related Art

Image forming apparatuses such as a printer and a copier employing an electrophotographic method have been widely used. In general image forming apparatuses, depending on factors such as variety in types and properties of sheets to be used, characteristics of components such as conveyance rollers, usage environment including temperature and humidity at the time of conveyance, or the like, the sheet might be conveyed in a deviated state in a direction orthogonal to a conveyance direction (hereinafter referred to as a sheet width direction). Due to this, executing printing processing in this state would decrease the printing position accuracy.

In view of this, conventionally, a dislocation amount in the sheet width direction is detected by a deviation sensor, and the sheet is moved in the sheet width direction by a pair of registration rollers on the basis of the detected dislocation amount, whereby the positional relationship of the sheet with respect to the image is adjusted, that is, deviation correction (registration swinging correction) is performed. For example, JP 2013-52964 A discloses a an image forming apparatus that performs deviation correction of a sheet of moving the registration roller in the sheet width direction in a state where the registration roller holds the sheet on the basis of a detection result of a sheet end by a line sensor, and that judges whether to return the registration roller to a reference position after the deviation correction.

Unfortunately, however, the image forming apparatus described in JP 2013-52964 A includes the following problems. In the deviation correction, in order to continuously print a plurality of sheets, when the sheet is moved in the sheet width direction by the registration roller, there is a need to return the registration roller to the original reference position (home position) before a next sheet reaches the registration roller. For this reason, it is typical to set a value for a sheet interval that allows a margin in consideration of the time until the registration roller returns to the original reference position. Unfortunately, however, while setting the sheet interval in this manner enables reliable execution of the deviation correction there is a problem that the productivity in printing is degraded by setting wide sheet intervals.

### SUMMARY

The present invention has been made in view of the above problems, and an object of the present invention is to provide an image forming apparatus capable of performing deviation correction with high accuracy and preventing degradation of productivity.

To achieve the abovementioned object, according to an aspect of the present invention an image forming apparatus reflecting one aspect of the present invention comprises: a conveyor that conveys a sheet; a detector that detects an end position of the sheet conveyed by the conveyor in a second direction orthogonal to a first direction being a conveyance direction; a corrector that corrects deviation of the sheet by moving the sheet in the second direction on the basis of a detection result of the end position of the sheet in the second direction detected by the detector, and a hardware processor that obtains variation information based on the end position of the sheet detected by the detector, and adjusts an interval of the conveyed sheet while controlling operation of the corrector on the basis of the obtained variation information.

### BRIEF DESCRIPTION OF THE DRAWING

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating an exemplars, configuration of an image forming system according to an embodiment of the present invention;

FIG. 2 is a diagram illustrating an exemplary configuration of a registration part;

FIGS. 3A and 3B are diagrams for illustrating conveyance variation of a sheet in a front side conveyance path and a back side conveyance path;

FIG. 4 is a diagram for comparing a sheet interval according to an embodiment of the present invention and a sheet interval according to a conventional technique; and

FIG. 5 is a flowchart illustrating exemplary operation of an image forming apparatus at the time of executing a job.

### DETAILED DESCRIPTION OF EMBODIMENTS

Hereinafter, preferred embodiments of the present invention will be described in detail with reference to the drawings. However, the scope of the invention is not limited to the disclosed embodiments. Note that, for the purposes of explanation, proportions of dimensions in the drawings may be expanded, in some cases, and may differ from the proportions in reality.

[Exemplary Configuration of Image Forming System 500]

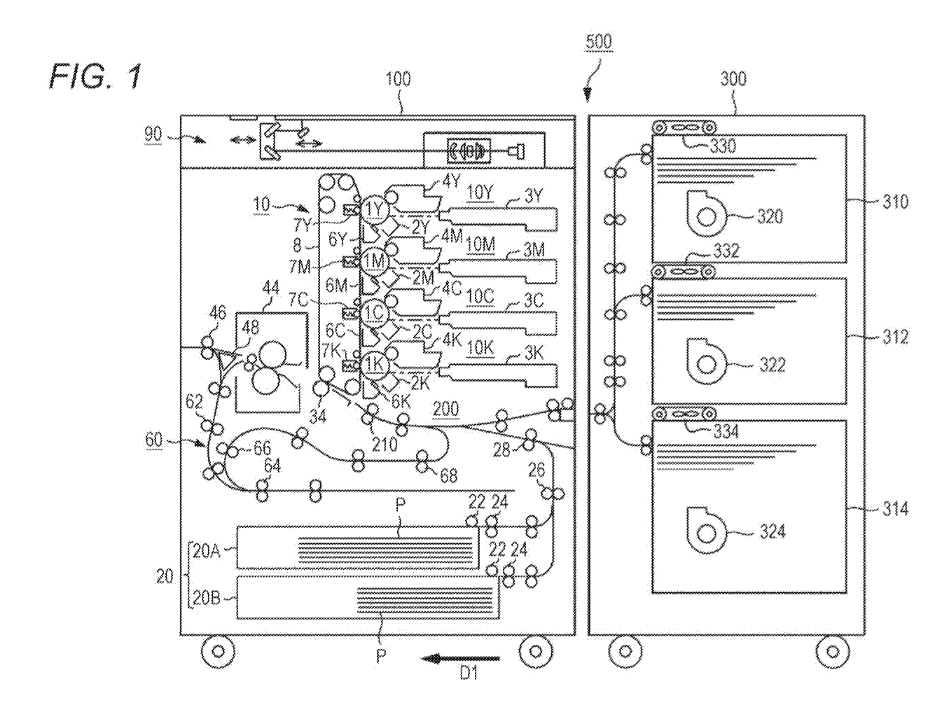

FIG. 1 illustrates an exemplary configuration of an image forming system 500 according to an embodiment of the present invention. As illustrated in FIG. 1, the image forming system 500 includes an image forming apparatus 100 and a large-capacity sheet feeding apparatus 300. While the image forming apparatus 100 illustrated in FIG. 1 forms a color image, the present invention is not limited to the image forming apparatus that forms a color image, but may also be applied to an image forming apparatus that forms a monochrome image.

First, the image forming apparatus 100 will be described. As illustrated in FIG. 1, the image forming apparatus 100 is referred to as a tandem type image forming apparatus, and includes an image reader 90, an image forming part 10, an intermediate transfer belt 8, a sheet feeder 20, a registration part 200, a fixing part 44, and an automatic sheet reverse conveyance unit 60 (auto duplex unit: (hereinafter referred to as an ADU).

The image reader 90 scans and exposes a document placed on a document stage or a document conveyed by an automatic document conveyor (not illustrated) by an optical system of the scanning exposure apparatus, and the image of the scanned document is photoelectrically converted by a charge coupled device (CCD) image sensor, thereby generating an image information signal. The image information signal undergoes analog processing, analog/digital (hereinafter referred to as A/D) conversion processing, shading correction, image compression processing, or the like, by an image processor (not illustrated), then, is output to the image forming part 10.

The image forming part 10 forms an image by an electrophotographic method, and includes an image forming unit 10Y that forms an image of yellow (Y) color, an image forming unit 10M that forms an image of magenta (M), an image forming unit 10C that forms a cyan (C) color image, and an image forming unit 10K that forms a black (K) color image. In this example, common function names, for example, Y, M, C, and K indicating the colors to be formed are added to the reference numeral 10 in description.

The image forming unit 10Y includes a photosensitive drum 1Y, a charger 2Y arranged around the photosensitive drum 1Y, an exposure part (optical writer) 3Y, a developing part 4Y and a cleaning part 6Y. The image forming unit 10M includes a photosensitive drum 1M, a charger 2M arranged around the photosensitive drum 1M, an exposure part 3M, a developing part 4M, and a cleaning part 6M. The image forming unit 10C includes a photosensitive drum 1C, a charger 2C arranged around the photosensitive drum 1C, an exposure part 3C, a developing part 4C, and a cleaning part 6C. The image forming unit 10K includes a photosensitive drum 1K, a charger 2K arranged around the photosensitive drum 1K, an exposure part 3K, a developing part 4K, and a cleaning part 6K.

The photosensitive drums (image carriers) 1Y, 1M, 1C, and 1K, the chargers 2Y, 2M, 2C, and 2K, the exposure parts 3Y, 3M, 3C, and 3K, the developing parts 4Y, 4M, 4C, and 4K, the cleaning parts 6Y, 6M, 6C, and 6K and primary transfer rollers 7Y, 7M, 7C, and 7K in the image forming units 10Y, 10M, 10C, and 10K have configurations common to individual components. Hereinafter, the components will be denoted without adding Y, M, C, and K unless distinction is needed.

The charger 2 charges the surface of the photosensitive drum 1 substantially uniformly. The exposure part 3 is constituted, for example, with an LED print head (LPH) including an LED array and an imaging lens, and a laser exposure scanning apparatus of a polygon mirror type, and performs laser light scanning on the photosensitive drum 1 on the basis of image information signal and forms an electrostatic latent image. The developing part 4 develops the electrostatic latent image formed on the photosensitive dram 1 by toner. As a result, a toner image as a visible image is formed on the photosensitive drum 1.

The intermediate transfer belt 8 is constituted with an endless belt, and stretched and rotatably supported by a plurality of rollers. The primary transfer roller 7 and the photosensitive drum 1 are rotated in conjunction with the rotation of the intermediate transfer belt 8. A predetermined voltage is applied between the primary transfer roller 7 and the photosensitive drum 1, whereby the toner image formed on the photosensitive drum 1 is transferred onto the intermediate transfer belt 8 (primary transfer).

The sheet feeder 20 includes a plurality of sheet feeding trays 20A and 20B containing sheets P of A3 and A4 sizes. The sheet P conveyed by the conveyance rollers 22, 24, 26, 28, or the like, from the sheet feeding trays 20A and 20B is conveyed to the registration part 200. The number of sheet feeding trays is not limited to two.

The registration part 200 connects the bending of the sheet P and corrects the deviation. After the bending, or the like, of the sleet P is corrected, the sheet P is conveyed to a secondary transfer roller 34 in accordance with a conveyance timing of the toner image transferred to the intermediate transfer belt 8. In the secondary transfer roller 34, toner images of Y, M, C, and K colors transferred onto the intermediate transfer belt 8 are collectively transferred onto a surface of the sheet P (secondary transfer). The sheet P that has received secondary transferred image is conveyed to the fixing part 44 on the downstream side in a sheet conveyance direction D1.

The fixing part 44 includes a pressure roller and a heating roller. The fixing part 44 fixes the toner image on a surface of the sheet P to the sheet P by pressurizing and heating processing onto the sheet P to which the toner image has been transferred by the secondary transfer roller 34.

On the downstream side of the fixing part 44 in the sheet conveyance direction D1, there is provided a conveyance path switcher 48 for switching the conveyance path of the sheet P to either a sheet discharge path side or an ADU 60 side. The conveyance path switcher 48 performs switching control of the conveyance path on the basis of the selected print mode (single-sided print mode, duplex print mode, etc.). After completion of single-side printing in the single-side print mode or duplex printing in the duplex print mode for the sheet P, the sheet P is discharged onto a discharge tray by a discharge roller 46.

In the case of forming an image on a back side of the sheet P in the duplex print mode, the sheet P having an image being formed on a front side thereof is conveyed to the ADU 60 via the conveyance roller 62, or the like. In a switchback path of the ADU 60, the sheet P is conveyed to a U-turn path part in a state where the trailing end of the sheet P is at the head by reverse rotation control of an ADU roller 64, and then, re-fed in an inverted state to the secondary transfer part by conveyance rollers 66, 68, or the like, provided at the U-turn path part.

Next, the large-capacity sheet feeding apparatus 300 will be described. The large-capacity sheet feeding apparatus 300 is connected to the upstream side of the image forming apparatus 100 in the sheet conveyance direction D1, stores a large amount of sheets P, and feeds the sheet P one by one to the image forming apparatus 100. The large-capacity sheet feeding apparatus 300 includes sheet feeding trays 310, 312, and 314 for storing sheets P of A4 size, or the like, blowers 320, 322, and 324, and suction conveyors 330, 332, and 334.

The blower 320 is arranged to the side of each of the sheet feeding trays 310. The blower 320 includes a blowing fan and blows separation air toward a sheet bundle to float the sheet P placed on the uppermost portion of the sleet bundle.

The blower 322 is arranged to the side of each sheet feeding tray 312. The blower 322 includes a blowing fan and blows separation air toward a sheet bundle to float the sheet P placed on the uppermost portion of the sheet bundle.

The blower 324 is arranged to the side of each of the sheet feeding trays 314. The blower 324 includes a blowing fan and blows separation air toward a sheet bundle to float the sheet P placed on the uppermost portion of the sheet bundle.

The suction conveyor 330 includes a belt and a suction fan arranged on the upper side in each of the sheet feeding trays 310 and including a large number of through holes. The suction conveyor 330 sucks the sheet P flowed by the blower 320 onto the belt by drive of the suction fan, and conveys the sucked sheet P toward the image forming apparatus 100.

The suction conveyor 332 includes a belt and a suction fan arranged on the upper side in each of the sheet feeding trays 312 and including a large number of through holes. The suction conveyor 332 sucks the sheet P flowed by the blower 322 onto the belt by drive of the suction fan, and conveys the sucked sheet P toward the image forming apparatus 100.

The suction conveyor 334 includes a belt and a suction fan arranged on the upper side in each of the sheet feeding trays 314 and including a large number of through holes. The suction conveyor 334 sucks the sheet P floated by the blower 324 to the belt by driving the suction fan, and conveys the sucked sheet P toward the image forming apparatus 100.

Note that it is also allowable to provide the blowers for blowing, to the sheet P, air for separating the sheet P sucked by the suction conveyors 330, 332, and 334 from the belt, on the front side of each of the sheet feeding trays 310, 312, and 314.

[Exemplary Configuration of Registration Part 200, or the Like]

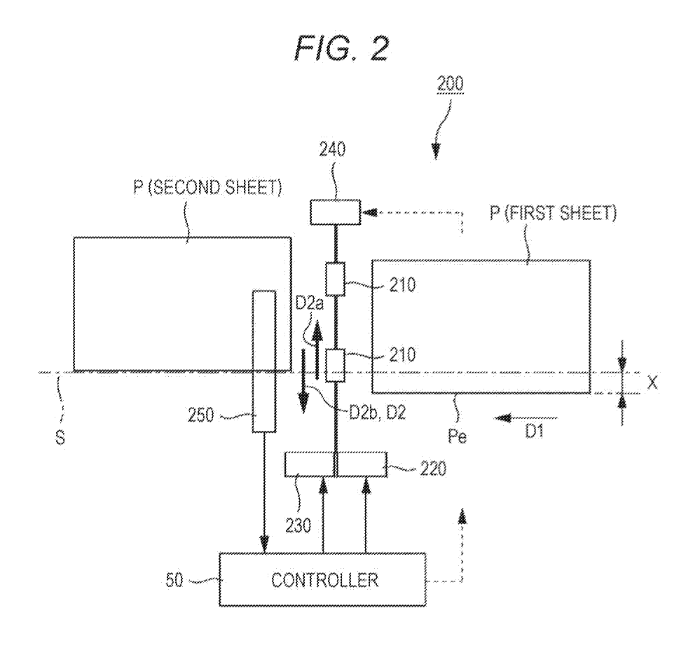

FIG. 2 illustrates an example of a functional configuration of the registration part 200, or the like, constituting the image forming apparatus 100. As illustrated in FIG. 2, the registration part 200 includes a registration roller 210, a swinging part 220, a crimp-separator 230, a conveyor 240, and a deviation detector 250. Each of the swinging part 220, the crimp-separator 230, the conveyor 240 and the deviation detector 250 is connected to a controller 50.

The controller 50 control entire operation of the apparatus and includes a central processing unit (CPU), a read only memory (ROM), and a random access memory (RAM). By executing software (program) read from the ROM, the CPU controls each of the components of the image forming apparatus 100, thereby achieving processing such as sheet interval adjustment based on variation in the deviation amount of the sheet P. The controller 50 also functions as a main calculation part, and controls operation of the blowers 320, 322, and 324 and the suction conveyors 330, 332, and 334 in conjunction with the controller provided in the large-capacity sheet feeding apparatus 300.

The registration roller 210 corresponds to an example of a corrector, and is constituted with a pair of rollers formed of a resin material arranged to face each other. The registration roller 210 corrects the bending of the sheet P by creating a loop by the tip abutment of the sheet P, or corrects the deviation of the sheet P by swinging the sheet D in a sheet width direction D2 in a state of holding the sheet P.

The swinging part 220 corresponds to an example of a corrector, and includes a driving motor constituted with a stepping motor, or the like, a rack, a pinion gear, or the like. The driving motor of the swinging part 220 is driven on the basis of a driving signal (correction value) supplied from the controller 50 so as to operate the rack and the pinion gear, thereby moving the registration roller 210 in the sheet width direction D2.

The crimp-separator 230 includes a driving motor constituted with a stepping motor, or the like, a cam, a cam follower or the like. The driving motor of the crimp-separator 230 rotates the cam on the basis of the driving signal supplied from the controller 50 to press the cam follower so as to shift the registration roller 210 from a crimping state to a separated state, or rotates the cam to be separated from the cam follower so as to shift the registration roller 210 from the separated state to the crimping state.

The conveyor 240 is constituted with a driving motor such as a stepping motor and a DC brushless motor, for example, and driven on the basis of a driving signal supplied from the controller 50 to rotate the registration roller 210 forward or reverse.

The deviation detector 250 is provided downstream of the registration roller 210 in the sheet conveyance direction D1 and includes, for example, a line sensor including a plurality of photoelectric conversion devices linearly arranged along the sheet width direction D2 and an image sensor including photoelectric conversion devices arranged in a matrix. The deviation detector 250 reads an end position Pe of the sheet P to be conveyed in the sheet width direction D2, and supplies the read information indicating the end position Pc to the controller 50.

[Exemplary Operation of Registration Part 200 at Deviation Correction]

Next, exemplary operation of the registration part 200 at the time of deviation correction will be described with reference to FIG. 2. As illustrated in FIG. 2, the deviation detector 250 detects the end position Pe of the sheet P that reaches the registration roller 210 and is conveyed, in the sheet width direction D2, and stores information indicating the end position Pe of the sheet P to the controller 50. The controller 50 calculates a deviation amount X of the sheet P on the basis of the information indicating the end position Pe of the sheet P supplied from the deviation detector 250 and a preset reference position S, and outputs a driving signal on the basis of the calculated deviation amount X to the swinging part 220. The swinging part 220 swings the registration roller 210 in the sheet width direction D2a by the deviation amount X in a state of holding the sheet P.

Upon completion of the deviation correction, the controller 50 supplies a control signal for releasing nipping of the registration roller 210 to the crimp-separator 230 and supplies a control signal for causing the registration roller 210 to return to the home position, to the swinging part 220. The crimp-separator 230 releases the crimping of the registration roller 210 on the basis of an instruction from the controller 50. On the basis of the instruction from the controller 50, the swinging part 220 moves the registration roller 210 in the separated state in the sheet width direction D2b to return to the home position. Here, the time for the registration roller 210 to return to the home position is proportional to the deviation amount X of the sheet P. When the registration roller 210 returns to the home position, the crimp-separator 230 supplies a control signal to the crimp-separator 230 again to crimp the registration roller 210 in order to perform deviation correction of the next sheet P, or the like. In this manner, deviation correction of the sheet P is executed.

[Conveyance Variation Information of Sheet P]

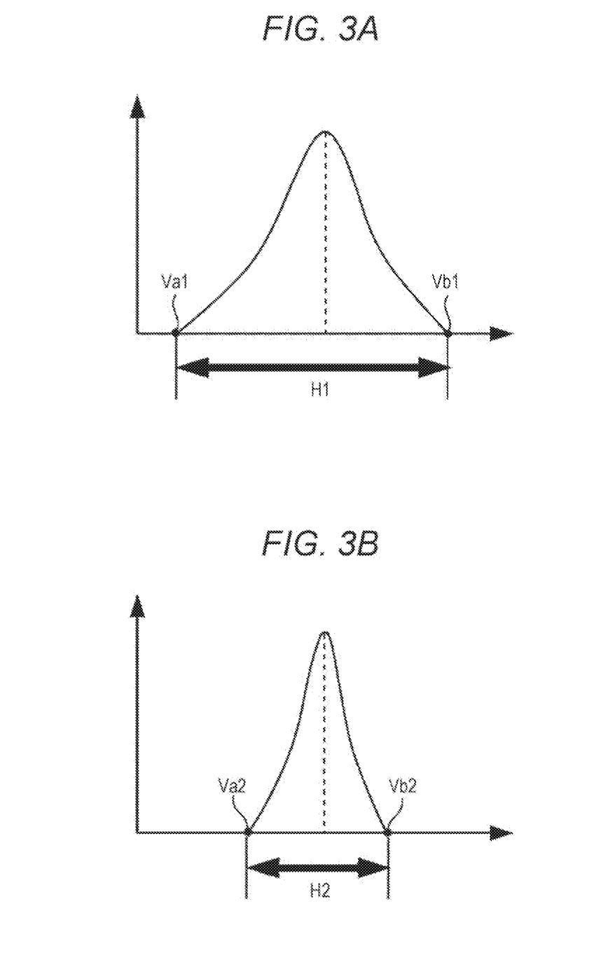

FIG. 3A illustrates variation in the end position Pc of the sheet P detected by the deviation detector 250 in a case where a plurality of sheets P is allowed to pass through a front side conveyance path (first conveyance path). FIG. 3B illustrates variation in the end position Pe of the sheet P detected by the deviation detector 250 in a case where the plurality of sheets P is allowed to pass through a back side conveyance path (second conveyance path). The graphs of FIGS. 3A and 3B are represented by standard deviation as an example.

Here, the front side conveyance path is a combination of a conveyance path from each of the sheet feeding trays 310, 312, and 314 of the large-capacity sheet feeding apparatus 300 to the discharge port and a conveyance path from a conveyance entrance of the image forming apparatus 100 to the registration roller 210. In a case where the sheet P is fed from the sheet feeder 20 of the image forming apparatus 100, the front side conveyance path functions as a conveyance path from the sheet feeding trays 20A and 20B to the registration roller 210. The back side conveyance path is a path combining a conveyance path on the downstream side of the secondary transfer roller 34 in the sheet conveyance direction D1, with a conveyance path from the ADU 60 to the registration roller 210.

In some cases in the front side conveyance path, connection dislocation might occur at the connection (conveyance path) between the large-capacity sheet feeding apparatus 300 and the image forming apparatus 100, or the sleet P might be set to the sheet feeding trays 310, 312, and 314 of the large-capacity sheet feeding apparatus 300 in a dislocated state. In addition, the conveyance path of the sheet P tends to be long. In such a case, the conveyance dislocation of the sheet P is increased, and when the deviation amount of the sheet P detected by the deviation detector 250 increases, a variation range also increases. Specifically, as illustrated in FIG. 3A, the deviation of the end position Pe with respect to the reference position S of the sheet P detected by the deviation detector 250 occurs within a range of a variation range H1. At this time, a lower limit value Va1 of the variation range H1 is, for example, −5 mm and an upper limit value Vb1 is, for example, +5 mm.

In contrast, in the back side conveyance path, the deviation of the sheet P is corrected to some extent by a guide plate (regulating member), or the like, provided in the ADU 60, or the like. Accordingly, the deviation amount of the sheet P detected by the deviation detector 250 is smaller with a smaller variation range compared with a case where the sheet P is caused to pass through the front side conveyance path. Specifically, as illustrated in FIG. 3B, the deviation of the end position Pe with respect to the reference position S of the sheet P detected by the deviation detector 250 occurs within a range of a variation range H2 narrower than the variation range H1. At this time, a lower limit value Va2 of the deviation amount of the variation range H2 is, for example, −3 mm and an upper limit value Vb2 is, for example, +3 mm.

[Sheet Interval]

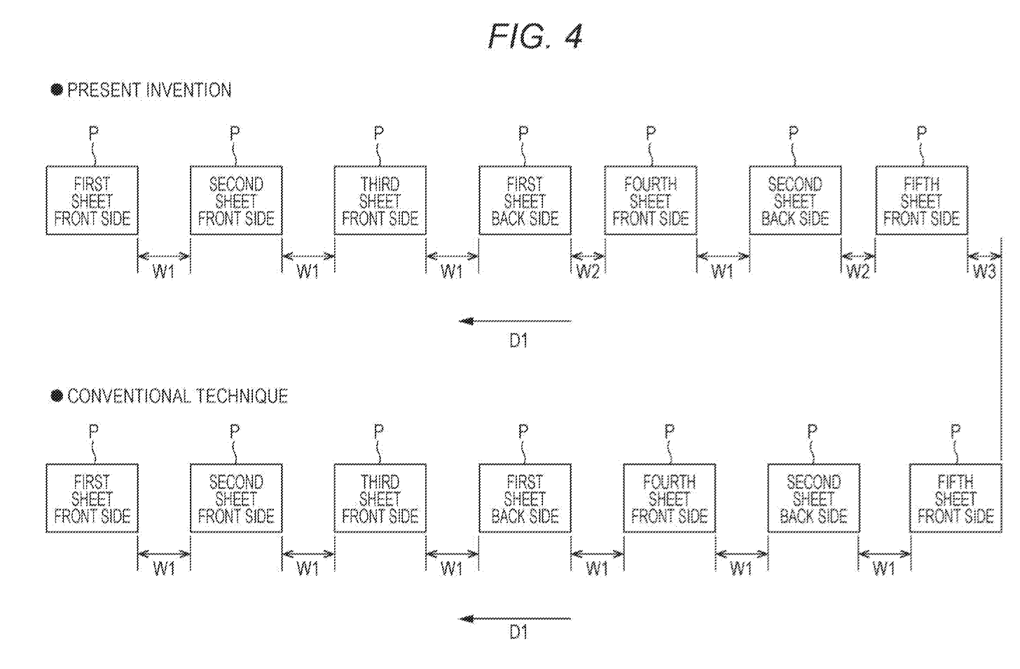

FIG. 4 is a diagram for comparing a sheet interval according to an embodiment of the present invention and a sheet interval according to a conventional technique. FIG. 4 illustrates states of sheet intervals in a case where the sheet P passes through the front side conveyance path, and thereafter, an image is formed on the front side of the sheet P by the secondary transfer roller 34, and subsequently, the sheet P passes through the back side conveyance path including the ADU 60 and an image is formed on the back side of the sheet P by the secondary transfer roller 34. In this example, it is assumed that three sheets P can be retained in the ADU 60.

As illustrated in the upper portion of FIG. 4, in the present embodiment, when printing an image on the front side of the sheet P, the sheet P passes through the front side conveyance path, and this increases the range of variation in the end position Pe of the sheet P, leading to an increase in the swinging time of the registration roller 210 accordingly. Therefore, in consideration of the time needed by the registration roller 210 to return to the home position, the sheet interval is set to an interval W1 with a margin.

In a case where an image is printed on the back side of the sheet P, the sheet P passes through the back side conveyance path, decreasing the variation range of the end position Pe of the sheet P, leading to a shorter swinging time of the registration roller 210 accordingly. In this case, since the time needed by the registration roller 210 to return to the home position is also reduced, and thus, the sheet interval of the next sheet P to be conveyed at the time of back side printing is set to a narrower interval W2 shorter than the interval W1.

In contrast, as illustrated in the lower portion of FIG. 4, the conventional technique provides no consideration of variations in deviation of the sheet P which are different for each of the conveyance paths, and accordingly, all the sheet intervals are set to the interval W1. That is, all the sheet intervals are set in accordance with the front side conveyance path that takes a longer time to return the registration roller 210 to the home position.

Therefore, according to the present embodiment, in the printing processing stage up to the front side of the fifth sheet P, it is possible to reduce the sheet interval by an interval W3 as compared with the conventional technique. This enables less spaced conveyance of the sheet P by the interval W3, and to reduce the conveyance time corresponding to the interval W3, leading to enhancement of productivity.

[Exemplary Operation of Image Forming Apparatus 100]

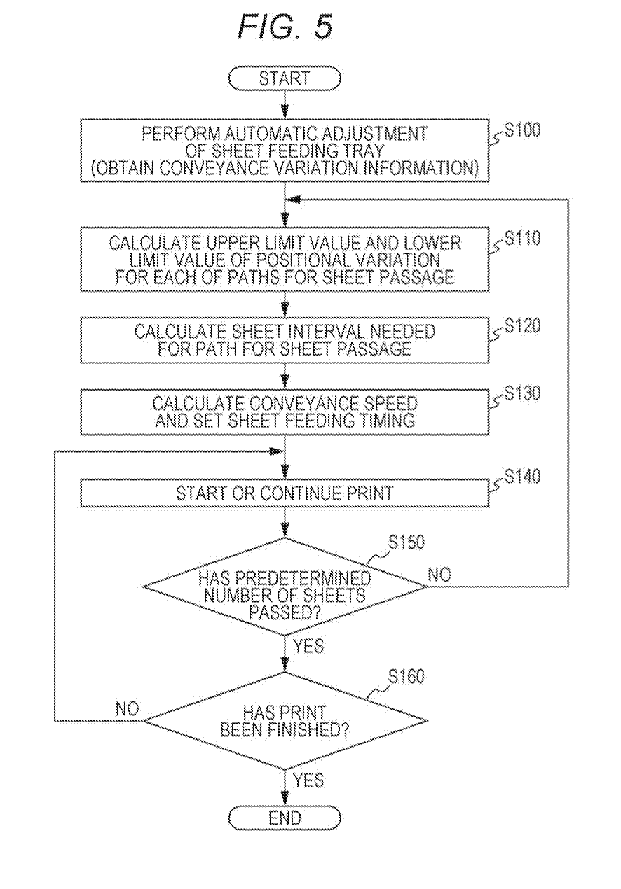

FIG. 5 is a flowchart illustrating exemplary operation of the image forming apparatus 100 at the time of executing a job. The controller 50 of the image forming apparatus 100 reads a program from a memory such as the ROM and executes it, thereby executing an operation sequence illustrated in the flowchart in FIG. 5.

As illustrated in FIG. 5, the controller 50 performs in step S100 automatic adjustment of the sheet feeding tray 310, or the like. Specifically, the controller 50 obtains conveyance variation information at the end position Pe of the sheet P by allowing dozens of the sheets P to pass through the front side conveyance path, or obtains conveyance variation information at the end position Pe of the sheet P by allowing dozens of the sheets P to pass through the back side conveyance path The operation of obtaining the conveyance variation information can be performed, for example, by a service person or a user at the time of shipment, installation, application, etc. of the image forming apparatus 100. Upon completion of step S100, the processing proceeds to step S110.

In step S110, the controller 50 obtains an upper limit value and a lower limit value of the conveyance variation information of the sheet P for each of the plurality of obtained sheet conveyance paths. For example, as illustrated in FIG. 3A, the upper limit value Vb1 and the lower limit value Va1 of the conveyance variation are obtained in the case of the front side conveyance path. Upon completion of step S110, the processing proceeds to step S120.

In step S120, the controller 50 calculates a necessary sheet interval on the basis of the calculated upper limit value and the lower limit value of the conveyance variation information for each of the sheet conveyance paths. Specifically, as illustrated in FIG. 4, in a case where an image is formed on the front side of the sheet P, the range of variation in the deviation amount of the sheet P increases, and accordingly, in consideration of the time taken by the registration roller 210 to return to the home position, the interval with the next sheet P to be conveyed next is set to a wide interval. In contrast, in a case where an image is formed on the back side of the sheet P, the range of variation in the deviation amount of the sheet P decreases, and accordingly, in consideration of less time taken by the registration roller 210 to return to the home position, the interval with the next sheet P to be conveyed next is set to a narrower interval. Upon completion of step S120, the processing proceeds to step S130.

In step S130, the controller 50 calculates the conveyance speed (page per minute: PPM) of each of the sheets P at the time of image formation on the basis of the calculated sheet interval for each of the conveyance paths and sets a sheet feeding timing of the sheet P to be fed from the large-capacity sheet feeding apparatus 300 and from the sheet feeder 20. That is, the conveyance speed of the sheet P is set so as to achieve the calculated sheet interval. Upon completion of step S130, the processing proceeds to step S140.

In step S140, the controller 50 starts printing on the basis of the set conveyance speed of sheet P. When step S140 is started, the processing proceeds to step S150.

In step S150, the controller 50 determines whether a predetermined number of sheets set beforehand has passed (printed). This is because it is conceivable that variation in the deviation amount of the sheet P also changes due to a change in the number of sheets that have passed. In a case where the controller 50 determines that the predetermined number of sheets set beforehand has passed, the controller 50 returns to step S110 and executes the above-described processing in steps S110 to S140. Specifically, variation information of the deviation amount of the sheet P in each of the conveyance paths is obtained again, and the conveyance speed, or the like, of the sheet P is calculated from the obtained variation information so as to be updated.

In contrast, in a case where the controller 50 determines that the predetermined number of sheets set beforehand has not passed, the controller 50 proceeds to step S160. In step S160, the controller 50 determines whether printing in the job has finished. In a case where the controller 50 determines that printing has not finished, the controller 50 returns to step S140 and continuously executes the remaining printing. In contrast, in a case where the controller 50 determines that the printing has finished, the controller 50 finishes a series of printing processing by the job.

As described above, according to the present embodiment, the sheet interval is determined in consideration of the variation information of the deviation amount of the sheet P in each of the conveyance paths such as the front side conveyance path and the back side conveyance path. For example, in a case where the sheet P passes through the back side conveyance path, the variation range of the deviation amount of the sheet P decreases, and accordingly, the sheet interval of the sheet P to be conveyed next is set to be a shorter interval. As a result, the productivity at the time of printing can be enhanced as compared with the case of the conventional technique.

Although the present invention has been described with reference to the embodiments, the technical scope of the present invention is not limited to the scope described in the above embodiment. Various modifications or enhancement can be added to the above-described embodiments without departing from the scope and spirit of the present invention. In addition, one or more of the requirements described in the above embodiment may be omitted. Such modifications, enhancement, and omissions are also included in the technical scope of the present invention.

For example, as a technique for adjusting the sheet interval between the sheets, the technique disclosed below can be adopted. Specifically, in a case where the end position Pc of the sheet P detected by the deviation detector 250 exceeds a preset threshold, it is possible to determine that deviation is generated in sheet P due to a position shift generated at the time of setting the sheet P in the large-capacity sheet feeding apparatus 300 or due to a positional shift generated at the time of suction of the sheet P to the suction conveyor 330, or the like.

In such a case, the controller 50 adjusts the volume of the air blown to the sheet P from the blowing fans of the blowers 320, 322, and 324 on the basis of the conveyance variation information of the sheet P, and returns (corrects) the position shift at the time of setting of the sheet P in the large-capacity sheet feeding apparatus 300, thereby suppressing the deviation of the sheet P. The controller 50 also adjusts the volume (suction timing) of the air for suction by each of the suction fans of the suction conveyors 330, 332, and 334 on the basis of the variation information of the sheet P, and suppresses deviation of the sheet P by suppressing the position shift of the sheet P at the time of suction of the sheet P in the large-capacity sheet feeding apparatus 300. Note that both the adjustment of the air volume of the blower 320 or the like, and the adjustment of the air volume of the suction conveyor 330 or the like, may be combined with each other.

According to the present embodiment, the conveyance variation information is reflected in the air volume of the blower 320, or the like, and the air volume of the suction conveyor 330, or the like, and thus, it is possible to prevent double feeding and to reduce the variation in the sheet P to reach the registration roller 210. This makes it possible to reduce the variation in conveyance of the sheet P, leading to a decreased swing range of the registration roller 210. As a result, this enables setting narrower interval between the sheets as a whole, leading to further enhancement of the productivity.

Note that the blower 320 and the suction conveyor 330 described in the large-capacity sheet feeding apparatus 300 can also be provided in the sheet feeder 20 of the image forming apparatus 100. Also in this case, as described above, the sheet interval as a whole can be reduced by adjusting the volume of the air blown from the blower and the suction timing by the suction conveyor on the basis of the conveyance variation information of the deviation amount of the sheet P. Here, the conveyance variation information in the case of allowing the sheet P to pass from the sheet feeder 20 is a dislocation range between the variation range H1 illustrated in FIG. 3A and the variation range H2 illustrated in FIG. 3B.

Moreover, the controller 50 may adjust the swing speed of the registration roller 210 in the sheet width direction D2 by controlling the excitation voltage, or the like, of the driving motor for swinging the registration roller 210 on the basis of the conveyance variation information of the sheet P.

According to the present embodiment, it is possible to optimally set the speed of the drive motor of the swinging part 220, leading to prevention of step-out of the driving motor. Moreover, by setting the excitation voltage of the driving motor of the swinging part 220 to an optimum value, the power consumption of the swinging motor can be suppressed. In addition, since it is possible to narrow the sheet interval as a whole, it is possible to further enhance the productivity.

Furthermore, the controller 50 may correct the deviation of the sheet P by shifting an image center with respect to the sheet P by adjusting the writing position to the photosensitive drum 1 by the exposure part on the basis of the conveyance variation information of the sheet P.

According to the present embodiment, the operation amount of the driving motor of the swinging part 220 can be reduced more than assumed by changing the write position of the image on the basis of the conveyance variation information, making it possible to expand the swing adjustment range. Moreover, since the swinging time of the registration roller 210 can be shortened, it is possible to narrow the sheet interval as a whole, leading to enhancement of the productivity.

Although embodiments of the present invention have been described and illustrated in detail, it is clearly understood that the same is by way of illustration and example only and not limitation, the scope of the present invention should be interpreted by terms of the appended claims.

What is claimed is:

1. An image forming apparatus comprising:
a conveyor that conveys a sheet;
a detector that detects an end position of the sleet conveyed by the conveyor in a second direction orthogonal to a first direction being a conveyance direction;
a corrector that corrects deviation of the sheet by moving the sheet in the second direction on the basis of a detection result of the end position of the sheet in the second direction detected by the detector, and
a hardware processor that obtains variation information based on the end position of the sheet detected by the detector, and adjusts an interval of the conveyed sheet while controlling operation of the corrector on the basis of the obtained variation information.

2. The image forming apparatus according to claim 1, further comprising
a sheet feeding apparatus including a blower that floats the sheet contained in a sheet feeding tray and including a suction part that sucks and conveys the sheet floated by the blower,
wherein the hardware processor adjusts at least one of a volume of air blown out from the blower and a timing of suction by the suction part on the basis of the variation information.

3. The image forming apparatus according to claim 1,
wherein the hardware processor adjusts at least one of a moving speed of the corrector and an excitation voltage of a drive motor that drives the corrector on the basis of the variation information.

4. The image forming apparatus according to claim 1, further comprising
an image forming part including an image carrier that carries a toner image to be transferred onto a sheet and including an exposure part that writes an electrostatic latent image corresponding to the toner image on the image carrier,
wherein the hardware processor adjusts a writing position of the image on the image carrier by the exposure part on the basis of the variation information.

5. The image forming apparatus according to claim 1,
wherein the variation information is obtained by causing a sheet to pass through a predetermined conveyance path before or during printing.

6. The image forming apparatus according to claim 5,
wherein the predetermined conveyance path includes a first conveyance path used in a case where an image is formed on a front side of a sheet and includes a second conveyance path used in a case where an image is formed on a back side of the sheet.

7. The image forming apparatus according to claim 6,
wherein a variation range of the variation information in the first conveyance path is a first range, and a variation range of the variation information in the second conveyance path is a second range narrower than the first range.
